(19) United States
(12) Patent Application Publication
(10) Pub. No.: US 2026/0049208 A1
(43) Pub. Date: Feb. 19, 2026

(54) TIRE RUBBER COMPOSITION

(71) Applicant: THE YOKOHAMA RUBBER CO., LTD., HIRATSUKA-SHI, KANAGAWA (JP)

(72) Inventors: Takuji TAKAHASHI, HIRATSUKA-SHI, KANAGAWA (JP); Masaki SATO, HIRATSUKA-SHI, KANAGAWA (JP)

(21) Appl. No.: 19/101,776

(22) PCT Filed: Aug. 9, 2023
(86) PCT No.: PCT/JP2023/029099

§ 371 Date: Feb. 6, 2025

(30) Foreign Application Priority Data
Aug. 15, 2022 (JP) 2022-129189

(51) Int. Cl. C08L 15/00; B60C 1/00; B60C 11/00; C08K 5/548

(52) U.S. Cl. CPC C08L 15/00; B60C 1/0016; B60C 11/0008; C08K 5/548; B60C 2011/0016; C08L 2205/025; C08L 2205/035

(57) ABSTRACT

A rubber composition for a tire includes: 60-90 parts by mass of silica and 15 to 40 parts by mass of a thermoplastic resin blended in 100 parts by mass of a diene rubber having average glass transition temperature≤−50° C. and containing from 50-75 mass % of a terminal-modified styrene-butadiene rubber (SBR) (A) with average molecular weight of 300000-500000 and a glass transition temperature≤−50° C., 0-50 mass % of a terminal-modified SBR (B) with average molecular weight of ≥600000, and 0-30 mass % of a natural rubber; and a mercapto silane coupling agent 2-15 mass % of the silica mass. Total mass of the SBR (B) and the natural rubber is ≥⅓ of a mass of the SBR (A), a weight average molecular weight of a mixture of the SBR (B) and the natural rubber is ≥700000.

### TECHNICAL FIELD

The present invention relates to a rubber composition for a tire that can provide excellent wear resistance, wet performance, and low rolling resistance.

### BACKGROUND ART

A tire is required to have high levels of wear resistance, wet performance, and low rolling resistance in a compatible way. Further, along with the enhancement of the low rolling resistance, a tire is required to exhibit low rolling resistance even when the tire temperature is low, or in other words, the temperature dependency of the low rolling resistance is required to be low.

Patent Document 1 proposes to improve low rolling resistance, wet grip performance, and wear resistance using a rubber composition for a tire in which from 2 to 50 parts by weight of an aromatic modified terpene resin having a softening point of 100° C. or higher and two specific types of silica are blended per 100 parts by weight of a diene rubber containing from 5 to 50 wt. % of a terminal-modified solution polymerized styrene-butadiene rubber having a glass transition temperature of −50° C. or lower. However, a sufficient effect of reducing low rolling resistance and the temperature dependency thereof is not necessarily achieved with the invention described in Patent Document 1. In addition, in the invention described in Patent Document 1, a decrease in forming processability is observed, and thus an improvement is necessary. This decrease in forming processability occurs because the terminal-modified solution-polymerized styrene-butadiene rubber having a low glass transition temperature tends to have a low styrene content, and has poor cohesion during kneading, and the terminal-modified solution-polymerized styrene-butadiene rubber is sometimes designed to have a low molecular weight from the viewpoint of increasing polymerization rate and terminal modification efficiency. The composition thus has a tendency to show a decrease in green strength and elongation, causing problems such as rubber remaining in an extruder during an extrusion process or poor machining accuracy including an increase in surface irregularities on an extrusion molded article. Furthermore, when a silane coupling agent highly reactive with silica and rubber is used, there is a concern that plasticity of the rubber composition may be reduced, leading to a reduction in the quality of the extrusion molded article.

### CITATION LIST

### Patent Literature

Patent Document 1: JP 2013-227375 A

### SUMMARY OF INVENTION

### Technical Problem

An object of the present invention is to provide a rubber composition for a tire that excels in extrusion forming processability, while improving wear resistance, wet performance, and low rolling resistance beyond a level in the related art, and reducing the temperature dependency of the low rolling resistance.

### Solution to Problem

A rubber composition for a tire of the present invention that achieves the aforementioned object includes: from 60 to 90 parts by mass of silica and from 15 to 40 parts by mass of a thermoplastic resin in 100 parts by mass of a diene rubber, the diene rubber containing a terminal-modified styrene-butadiene rubber (A) and containing a natural rubber and/or a terminal-modified styrene-butadiene rubber (B); and a silane coupling agent having a mercapto structure at an amount from 2 to 15 mass % of the mass of the silica, wherein the terminal-modified styrene-butadiene rubber (A) may have a weight average molecular weight of from 300000 to 500000 and a glass transition temperature of −50° C. or lower, the terminal-modified styrene-butadiene rubber (B) may have a weight average molecular weight of 600000 or greater, a mixture containing the terminal-modified styrene-butadiene rubber (B) and the natural rubber may have a weight average molecular weight of 700000 or greater, the diene rubber may have an average glass transition temperature of −50° C. or lower, and in 100 mass % of the diene rubber, a content of the terminal-modified styrene-butadiene rubber (A) may be from 50 to 75 mass %, a content of the natural rubber may be from 0 to 30 mass %, and a total mass of the terminal-modified styrene-butadiene rubber (B) and the natural rubber may be ⅓ or more of the mass of the terminal-modified styrene-butadiene rubber (A).

### Advantageous Effects of Invention

Through the composition described above, the rubber composition for a tire of the present invention can provide excellent extrusion forming processability, while improving wear resistance, wet performance, and low rolling resistance beyond a level in the related art, and reducing the temperature dependency of the low rolling resistance.

Preferably, the terminal-modified styrene-butadiene rubber (B) has a unimodal molecular weight distribution curve with a molecular weight distribution (PDI) of less than 1.7 when measured by gel permeation chromatography. Moreover, a content of the terminal-modified styrene-butadiene rubber (B) in 100 mass % of the diene rubber is preferably from 0 to 50 mass %.

Preferably, the thermoplastic resin contains 25 mass % or more of a terpene resin, and when the terpene resin contains a unit derived from α-pinene, a content of the unit derived from α-pinene is 60 mass % or less. Moreover, the thermoplastic resin preferably has a glass transition temperature of from 40° C. to 120° C. Alternatively, the thermoplastic resin is preferably at least one selected from the group consisting of: a resin consisting of at least one selected from a terpene, a modified terpene, a rosin, a rosin ester, a C5 component, and a C9 component; and a resin with at least some double bonds hydrogenated in the resin; and the thermoplastic resin preferably has a glass transition temperature of from 40° C. to 120° C.

A tire having a tread portion made from the above-described rubber composition for a tire enables stable production of tires with excellent quality, showing good extrusion forming processability while enhancing wear resistance, wet performance, and low rolling resistance beyond a level in the related art, and reducing the temperature dependency of the low rolling resistance.

### BRIEF DESCRIPTION OF DRAWINGS

FIG. 1 is a cross-sectional view in a tire meridian direction, illustrating an embodiment of a tire made from the rubber composition for a tire of the present invention.

### DESCRIPTION OF EMBODIMENTS

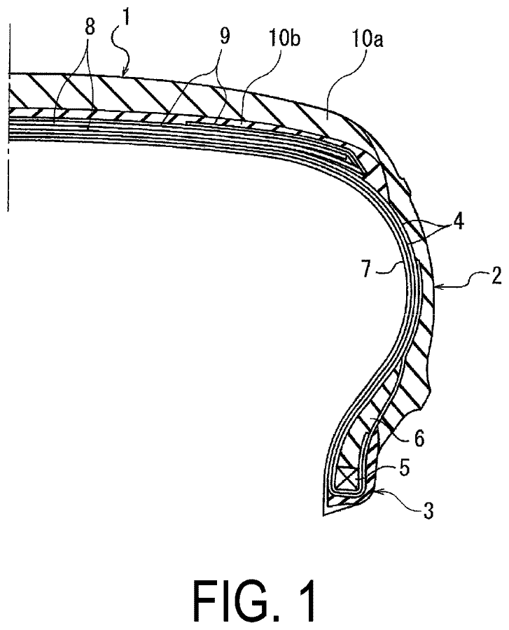

The rubber composition for a tire of the present invention can be suitably used in a tread portion or a side portion of a tire. Note that the tire may be a pneumatic tire or a non-pneumatic tire. FIG. 1 is a cross-sectional view illustrating an example of a pneumatic tire according to an embodiment. The pneumatic tire includes a tread portion 1, a side portion 2, and a bead portion 3.

In FIG. 1, two carcass layers 4, in which reinforcing cords extending in a tire radial direction are disposed at a predetermined interval in a tire circumferential direction and embedded in a rubber layer, extend between left and right bead portions 3. Both end portions of the two carcass layers 4 are folded back from the inside to the outside in a tire axial direction so as to sandwich a bead filler 6, around a bead core 5 embedded in the bead portion 3. An innerliner layer 7 is disposed inside the carcass layers 4. Two belt layers 8, in which reinforcing cords extending at an incline to the tire circumferential direction are disposed at a predetermined interval in the tire axial direction and are embedded in the rubber layer, are disposed on the outer circumferential side of the carcass layers 4 of the tread portion 1. The reinforcing cords of the two belt layers 8 are arranged in a crisscross manner with opposite inclination directions, in other words, the cord directions, with respect to the tire circumferential direction. A belt cover layer 9 is disposed at the outer circumferential side of the belt layers 8. The belt cover layer 9 may be either a full cover type that covers the entire belt layer or an edge cover type that covers an end portion of the belt layer in the tire width direction, or may be a combination of both types. The tread portion 1 is disposed at the outer circumferential side of the belt cover layer 9, and includes a cap tread 10a and an undertread 10b. The rubber composition for a tire of the present invention is preferably used in the tread portion 1 and the side portion 2, and is more preferably used in a cap tread 10a and an undertread 10b.

In the rubber composition for a tire of the present invention, the diene rubber contains a terminal-modified styrene-butadiene rubber (A) and contains a natural rubber and/or a terminal-modified styrene-butadiene rubber (B). In other words, the diene rubber is required to contain the terminal-modified styrene-butadiene rubber (A), and contains at least one selected from a natural rubber and the terminal-modified styrene-butadiene rubber (B).

The terminal-modified styrene-butadiene rubber (A) has a weight average molecular weight of from 300000 to 500000 and a glass transition temperature of −50° C. or lower. Incorporating the terminal-modified styrene-butadiene rubber (A) improves wear resistance while reducing rolling resistance and the temperature dependency thereof.

The terminal-modified styrene-butadiene rubber (A) has a glass transition temperature (which hereinafter may be referred to as “Tg”) of preferably from −75° C. to −50° C., and more preferably from −70° C. to −55° C. In the present description, the Tg can be measured as a midpoint temperature of a transition region in a thermogram obtained at a heating rate of 20° C./minute using differential scanning calorimetry (DSC). When the diene rubber is an oil extended product, the Tg is the Tg of the diene rubber containing no oil-extending component (oil).

The terminal-modified styrene-butadiene rubber (A) has a weight average molecular weight of preferably from 350000 to 500000, and more preferably from 400000 to 500000. The terminal-modified styrene-butadiene rubber (A) with the weight average molecular weight within such a range can further reduce rolling resistance. In the present description, the weight average molecular weight can be determined as a value measured by gel permeation chromatography (GPC) based on calibration with polystyrene.

The terminal-modified styrene-butadiene rubber (A) has a styrene content of preferably from 5 to 25 mass %, and more preferably from 10 to 20 mass %. When the styrene content is 5 mass % or more, the wet performance increases, and when the styrene content is 25 mass % or less, the temperature dependency of the rolling resistance is reduced, and thus such a styrene content is preferable. In the present description, the styrene content is a value measured by 1H-NMR.

The terminal-modified styrene-butadiene rubber (A) has a vinyl content of preferably from 10 to 45%, and more preferably from 15 to 40%. When the vinyl content is 10 mass % or more, the temperature dependency of the rolling resistance is reduced, and when the vinyl content is 45 mass % or less, the wear resistance is improved, and thus such a vinyl content is preferable. In the present description, the vinyl content is a value measured by ¹H-NMR.

The terminal-modified styrene-butadiene rubber (A) has at least one terminal modified by a functional group. Examples of the functional group include an epoxy group, a carboxy group, an amino group, a hydroxy group, an alkoxy group, a silyl group, an alkoxysilyl group, an amide group, an oxysilyl group, a silanol group, an isocyanate group, an isothiocyanate group, a carbonyl group, and an aldehyde group. Preferable examples of the functional group of the terminal-modified styrene-butadiene rubber (A) include a functional group having a polyorganosiloxane structure or an aminosilane structure. When the terminal-modified styrene-butadiene rubber (A) has an aminosilane or a functional group having the polyorganosiloxane structure or the aminosilane structure, dispersibility of the silica is improved, and a product excelling in low rolling resistance, wear resistance, and wet performance can be obtained.

The content of the terminal-modified styrene-butadiene rubber (A) is from 50 to 75 mass %, preferably from 50 to 70 mass %, and more preferably from 55 to 70 mass %, per 100 mass % of the diene rubber. When the content of the terminal-modified styrene-butadiene rubber (A) is less than 50 mass %, the effect of reducing the rolling resistance and the effect of improving the wear resistance cannot be sufficiently obtained. When the content of the terminal-modified styrene-butadiene rubber (A) exceeds 75 mass %, the wet performance decreases, and the extrusion forming processability may worsen.

The rubber composition for a tire contains the terminal-modified styrene-butadiene rubber (B) and/or a natural rubber. That is, the rubber composition for a tire may contain both the terminal-modified styrene-butadiene rubber (B) and the natural rubber, or may contain the terminal-modified styrene-butadiene rubber (B) or the natural rubber.

The terminal-modified styrene-butadiene rubber (B) has a weight average molecular weight of 600000 or greater, and the weight average molecular weight is selected such that the weight average molecular weight of a mixture of the terminal-modified styrene-butadiene rubber (B) and the natural rubber is 700000 or greater. The rolling resistance can be lowered and the temperature dependency thereof can be reduced by including the terminal-modified styrene-butadiene rubber (B). The weight average molecular weight of the terminal-modified styrene-butadiene rubber (B) is preferably from 600000 to 1500000, and more preferably from 700000 to 1300000. A rubber composition excelling in rolling resistance and temperature dependency of the same can be achieved by including the terminal-modified styrene-butadiene rubber (B) with the weight average molecular weight within such a range.

The weight average molecular weight of the mixture consisting of the terminal-modified styrene-butadiene rubber (B) and the natural rubber is 700000 or greater, preferably from 700000 to 1300000, and more preferably from 700000 to 1200000. When the weight average molecular weight of the mixture of the terminal-modified styrene-butadiene rubber (B) and the natural rubber is within such a range, issues of rubber remaining in an extruder during extrusion molding and an increase in surface irregularities of an extrusion molded article can be suppressed. The mixture consisting of the terminal-modified styrene-butadiene rubber (B) and the natural rubber is a blend prepared so as to have the same compounded ratio as that of the rubber composition for a tire. The weight average molecular weight may be measured by GPC, or may be calculated as a weighted average value from the weight average molecular weights of the terminal-modified styrene-butadiene rubber (B) and the natural rubber and the mass ratio at which the terminal-modified styrene-butadiene rubber (B) and the natural rubber are blended in the rubber composition.

The terminal-modified styrene-butadiene rubber (B) preferably has a unimodal molecular weight distribution curve with a molecular weight distribution (PDI) of less than 1.7 when measured by gel permeation chromatography. When the molecular weight distribution curve of the terminal-modified styrene-butadiene rubber (B) is unimodal, high molecular uniformity is achieved, and the terminal-modified styrene-butadiene rubber (B) is uniformly distributed and dispersed in the diene rubber, and thus higher affinity with silica can be achieved. The molecular weight distribution (PDI) is a ratio (Mw/Mn) of a weight average molecular weight (Mw) to a number average molecular weight (Mn) measured by gel permeation chromatography. When the molecular weight distribution (PDI) is less than 1.7, similar to the unimodal molecular weight distribution curve, the modified styrene-butadiene rubber can have increased molecular uniformity and be uniformly distributed and dispersed in the diene rubber, showing a higher affinity with silica. The molecular weight distribution (PDI) is more preferably 1.0 or more and less than 1.7, and more preferably from 1.1 to 1.6. Such a terminal-modified styrene-butadiene rubber (B) can be preferably obtained by polymerization in continuous mode.

In the present description, when the molecular weight distribution curve, the weight average molecular weight (Mw), and the number average molecular weight (Mn) of the terminal-modified styrene-butadiene rubber (B) are measured by gel permeation chromatography, examples of the measurement conditions can include the following. Note that the terminal-modified styrene-butadiene rubber (A) and the natural rubber can also be measured in the same manner.
Instrument: Gel permeation chromatography [GPC: HLC-8020, available from Tosoh Corporation]
Column: GMH-HR-H (available from Tosoh Corporation), two connected in series
Measurement temperature: 40° C.
Carrier gas: Helium
Flow rate: 5 mmol/L
Sample: 10 mg was dissolved in 10 mL THF
Injection volume: 10 AL
Detector: Detector: Differential refractometer (RI-8020)

At least one terminal of the terminal-modified styrene-butadiene rubber (B) is modified with a functional group. The functional group thereof can be appropriately selected from those exemplified as the functional group of the terminal-modified styrene-butadiene rubber (A) described above. The functional group of the terminal-modified styrene-butadiene rubber (B) may be the same as or different from the functional group of the terminal-modified styrene-butadiene rubber (A). Preferred examples of the functional group of the terminal-modified styrene-butadiene rubber (B) include a modifying group having a polyorganosiloxane structure or an aminosilane structure, an alkoxysilane group, an amino group, and a hydroxyl group.

The terminal-modified styrene-butadiene rubber (B) preferably has a Tg from −55° C. to −15° C., more preferably from −50° C. to −20° C., and even more preferably from −45° C. to −25° C. Note that the Tg of the terminal-modified styrene-butadiene rubber (B) is preferably higher than the Tg of the terminal-modified styrene-butadiene rubber (A). The terminal-modified styrene-butadiene rubber (B) with the Tg within such a range can improve wet performance, and is preferred.

The terminal-modified styrene-butadiene rubber (B) preferably has a styrene content from 20 to 45 mass %, and more preferably from 25 to 40 mass %. When the styrene content is 20 mass % or greater, the effect of improving wet performance can be further increased, and when the styrene content is 45 mass % or less, the impact on wear resistance can be suppressed, which is preferable.

The vinyl content of the terminal-modified styrene-butadiene rubber (B) is preferably from 15 to 50%, and more preferably from 20 to 45%. When the vinyl content is 15 mass % or more, wet performance can be improved, and when the vinyl content is 50 mass % or less, the impact on wear resistance can be suppressed, which is preferable.

The content of the terminal-modified styrene-butadiene rubber (B) is selected such that the total mass of the terminal-modified styrene-butadiene rubber (B) and the natural rubber is ⅓ or more of the mass of the terminal-modified styrene-butadiene rubber (A). A ratio of the total mass of the terminal-modified styrene-butadiene rubber (B) and the natural rubber to the mass of the terminal-modified styrene-butadiene rubber (A) is preferably from 1/3 to 1/1, and more preferably from 2/5 to 1/1. The terminal-modified styrene-butadiene rubber (B) and the natural rubber with the total mass within such a range can suppress rubber remaining in an extruder, and suppress an increase in surface irregularities of an extrusion-molded article.

The content of the terminal-modified styrene-butadiene rubber (B) is preferably from 0 to 50 mass %, more preferably from 10 to 40 mass %, and even more preferably from 20 to 30 mass %, per 100 mass % of the diene rubber.

The rubber composition for a tire preferably contains natural rubber at an amount from 0 to 30 mass %, preferably from 10 to 25 mass %, and more preferably from 15 to 25 mass %, per 100 mass % of the diene rubber. As described above, the content of the natural rubber is selected such that the total mass of the terminal-modified styrene-butadiene rubber (B) and the natural rubber is ⅓ or more of the mass of the terminal-modified styrene-butadiene rubber (A). By blending a natural rubber, green strength is improved, and rubber does not easily remain in an extruder. Furthermore, dispersibility of silica can be enhanced, and low rolling performance and wet performance can be improved by setting the natural rubber content to 30 mass % or less. The type of natural rubber is not particularly limited, and any natural rubber that is regularly used in a rubber composition for a tire may be used.

As described above, the weight average molecular weight of the natural rubber is selected such that the weight average molecular weight of the mixture composed of the terminal-modified styrene-butadiene rubber (B) and the natural rubber is 700000 or greater. The details are as described above.

The diene rubber in the rubber composition for a tire has an average glass transition temperature of −50° C. or lower, preferably from −65° C. to −50° C., and more preferably from −60° C. to −50° C. When the average glass transition temperature of the diene rubber falls within such a range, a balance between temperature dependency of rolling resistance and wet performance can be achieved at a high level. The average glass transition temperature of the diene rubber can be calculated as a weighted average value between the glass transition temperature of each rubber constituting the diene rubber and the respective mass fractions.

The rubber composition for a tire contains silica at an amount from 60 to 90 parts by mass, preferably from 65 to 85 parts by mass, and more preferably from 70 to 80 parts by mass per 100 parts by mass of the diene rubber. By blending silica into the rubber composition for a tire, rolling resistance and wet performance can be improved. If the silica content is less than 60 parts by mass, the effect of improving wet performance is not sufficiently obtained. Moreover, when the silica content exceeds 90 parts by mass, low rolling resistance tends to worsen.

As the silica, silica ordinarily used in a rubber composition for a tire is preferably used. For example, wet silica, dry silica, carbon-silica in which silica is supported on a surface of carbon black (dual-phase filler), and silica that is surface-treated with a compound reactive or miscible with both silica and rubber, such as a silane coupling agent or polysiloxane, can be used. Among these, wet silica having hydrous silicic acid as a main component is preferred.

Furthermore, together with the silica, a silane coupling agent having a mercapto structure is preferably blended to enhance dispersibility of the silica, and further improve wet performance. In the present description, the silane coupling agent having a mercapto structure refers to a silane coupling agent having a mercapto group (—SH) and a silane coupling agent having a —S—C(═O)— bond in the main chain. Here, the —S—C(═O)— bond is easily dissociated into a mercapto group (—SH) at a high temperature. The silane coupling agent is blended in an amount of from 2 to 15 mass %, preferably from 3 to 12 mass %, and more preferably from 3 to 9% in relation to the mass of the silica. When the silane coupling agent is blended in an amount of less than 2 mass % of the silica mass, the effect of improving dispersibility of the silica cannot be adequately achieved. Furthermore, when the silane coupling agent is blended in an amount exceeding 15 mass %, the diene rubber component tends to be easily gelified, and thus the desired effect cannot be achieved.

Preferable examples of the silane coupling agent having a mercapto group include a silane coupling agent represented by the average compositional formula of Formula (1) below and a silane coupling agent represented by the following Formula (2).

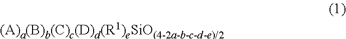

where in Formula (1), A represents a divalent organic group containing a sulfide group, B represents a monovalent hydrocarbon group having from 5 to 10 carbons, C represents a hydrolyzable group, D represents an organic group containing a mercapto group, R¹ represents a monovalent hydrocarbon group having from 1 to 4 carbons, and a to e satisfy the relationships: 0≤a<1, 0<b<1, 0<c<3, 0<d<1, 0≤e<2, and 0<2a+b+c+d+e<4.

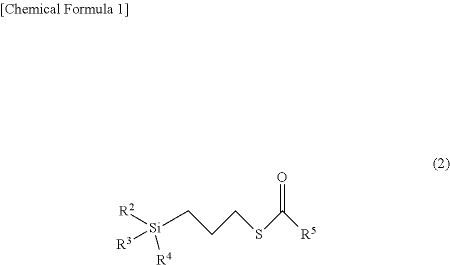

where in Formula (2), R² to R⁴ are each independently an alkyl group or an alkoxy group of from 1 to 6 carbons, at least one of which is an alkoxy group, and R⁵ is an alkyl group of 3 to 10 carbons.

The silane coupling agent represented by Formula (1) above preferably includes a polysiloxane backbone. The polysiloxane backbone may be a straight-chain, branched, or three-dimensional structure, or a combination of these.

In Formula (1) above, the hydrocarbon group B is a monovalent hydrocarbon group having from 5 to 10 carbons, preferably a monovalent hydrocarbon group having from 6 to 10 carbons, and more preferably a monovalent hydrocarbon group having from 8 to 10 carbons. Examples thereof include a hexyl group, an octyl group, and a decyl group. This can allow protection of the mercapto group, extension of Mooney scorch time, and achievement of better processability (scorch resistance), and better low rolling resistance. The subscript b of the hydrocarbon group B is more than 0 and preferably satisfies 0.10≤b≤0.89.

Furthermore, in Formula (1) above, the organic group A represents a divalent organic group containing a sulfide group (which hereinafter is also referred to as “sulfide group-containing organic group”). When the sulfide group-containing organic group is contained, better low heat build-up and processability (especially maintenance and extension of Mooney scorch time) are achieved. Thus, the subscript a of the sulfide group-containing organic group A is preferably more than 0, and more preferably satisfies 0<a≤0.50. The sulfide group-containing organic group A may contain a hetero atom such as an oxygen atom, a nitrogen atom, or a sulfur atom.

Among these, the sulfide group-containing organic group A is preferably a group represented by Formula (3) below.

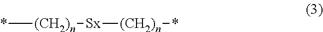

where in Formula (3) above, n represents an integer of 1 to 10, x represents an integer of 1 to 6, and * represents a bonding position.

Specific examples of the sulfide group-containing organic group A represented by General Formula (3) above include *—CH₂—S₂—CH₂—*, *—C₂H₄—S₂—C₂H₄—*, *—C₃H₆—S₂—C₃H₆—*, *—C₄H₈—S₂—C₄H₈—*, *—CH₂—S₄—CH₂—*, *—C₂H₄—S₄—C₂H₄—*, *—C₃H₆—S₄—C₃H₆—*, and *—C₄H₈—S₄—C₄H₈—*.

The silane coupling agent containing the polysiloxane represented by the average compositional formula of General Formula (1) above has excellent affinity and/or reactivity with silica due to the presence of the hydrolyzable group C. The subscript c of the hydrolyzable group C in General Formula (1) preferably satisfies 1.2≤c≤2.0 for the reason that better low heat build-up and processability (scorch resistance) are achieved and better dispersibility of the silica is achieved. Specific examples of the hydrolyzable group C include an alkoxy group, a phenoxy group, a carboxyl group, and an alkenyloxy group. From the perspective of achieving good dispersibility of silica and better processability (scorch resistance), the hydrolyzable group C is preferably a group represented by General Formula (4) below.

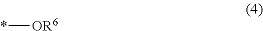

In General Formula (4) above, * represents a bonding position. Furthermore, R⁶ represents an alkyl group having from 1 to 20 carbons, an aryl group having from 6 to 10 carbons, an aralkyl group (aryl-alkyl group) having from 6 to 10 carbons, or an alkenyl group having from 2 to 10 carbons, and among these, an alkyl group having from 1 to 5 carbons is preferred.

Specific examples of the alkyl group having from 1 to 20 carbons include a methyl group, an ethyl group, a propyl group, a butyl group, a hexyl group, an octyl group, a decyl group, and an octadecyl group. Specific examples of the aryl group having from 6 to 10 carbons include a phenyl group, and a tolyl group. Specific examples of the aralkyl group having from 6 to 10 carbons include a benzyl group, and a phenylethyl group. Specific examples of the above alkenyl group having from 2 to 10 carbons include a vinyl group, a propenyl group, and a pentenyl group.

Since the silane coupling agent containing polysiloxane represented by the average compositional formula of General Formula (1) above has an organic group D containing a mercapto group, the silane coupling agent can interact and/or react with the diene rubber, and thus excellent low heat build-up is achieved. The subscript d of the organic group D containing a mercapto group preferably satisfies 0.1≤d≤0.8. From the perspective of achieving good dispersibility of silica and even better processability (scorch resistance), the organic group D containing a mercapto group is preferably a group represented by General Formula (5) below.

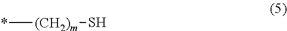

In General Formula (5) above, m represents an integer of from 1 to 10, and particularly preferably an integer of from 1 to 5. In the formula, * represents a bonding position.

Specific examples of the group represented by General Formula (5) above include *—CH₂SH, *—C₂H₄SH, *—C₃H₆SH, *—C₄H₈SH, *—C₅H₁₀SH, *—C₆H₁₂SH, *—C₇H₁₄SH, *—C₈H₁₆SH, *—CH₁₈SH, and *—C₁₀H₂₀SH.

In General Formula (1) above, R¹ represents a monovalent hydrocarbon group having from 1 to 4 carbons. Examples of the hydrocarbon group R¹ include a methyl group, an ethyl group, a propyl group, and a butyl group.

In the silane coupling agent represented by the General Formula (2), R² to R⁴ each independently represent an alkyl group or an alkoxy group having from 1 to 6 carbons. At least one of R² to R⁴ represents an alkoxy group. The alkyl group and the alkoxy group may be linear or branched. R² to R⁴ may be the same or different from each other. Examples of R² to R⁴ include a methoxy group, an ethoxy group, a propoxy group, a butoxy group, a pentyloxy group, a hexyloxy group, a methyl group, an ethyl group, a propyl group, a butyl group, a pentyl group, and a hexyl group.

In General Formula (2), R⁵ represents an alkyl group having from 3 to 10 carbons. R⁵ may be linear or branched, and examples thereof include an n-propyl group, an s-propyl group, an n-butyl group, an s-butyl group, a t-butyl group, an n-pentyl group, a 1,1-dimethylpropyl group, an n-hexyl group, a 1,1-dimethylbutyl group, an n-heptyl group, a 1,1-dimethylpentyl group, an n-octyl group, a 1,1-dimethylhexyl group, an n-nonyl group, and an n-decyl group.

Examples of the silane coupling agent represented by General Formula (2) include 3-octanoylthio-1-propyltriethoxysilane, 3-octanoylthio-1-propylethyldiethoxysilane, 3-hexanoylthiopropyltriethoxysilane, 3-decanoylthiopropyltriethoxysilane, 3-hexanoylthiopropyltrimethoxysilane, and 3-decanoylthiopropyltrimethoxysilane.

By blending another filler besides the silica in the rubber composition for a tire, strength of the rubber composition can be increased, and tire durability can be ensured. Examples of the other filler include inorganic fillers, such as carbon black, calcium carbonate, magnesium carbonate, talc, clay, alumina, aluminum hydroxide, titanium oxide, calcium sulfate, mica, and barium sulfate; and organic fillers, such as cellulose, lecithin, lignin, and dendrimer.

Moreover, among these fillers, by blending carbon black in particular, excellent strength of the rubber composition can be obtained, and wear resistance can be improved. As the carbon black, carbon black such as furnace black, acetylene black, thermal black, channel black, and graphite can be blended. Of these, furnace black is preferred. Specific examples thereof include SAF, ISAF, ISAF-HS, ISAF-LS, IISAF-HS, HAF, HAF-HS, HAF-LS, and FEF. These types of carbon black may be used alone or in combination of two or more types thereof. Surface-treated carbon black in which these types of carbon black are chemically modified with various acid compounds can also be used.

The rubber composition for a tire contains a thermoplastic resin blended at an amount from 15 to 40 parts by mass, preferably from 15 to 35 parts by mass, and more preferably from 17 to 30 parts by mass, per 100 parts by mass of the diene rubber. By blending the thermoplastic resin, wear resistance is improved, the Tg of the rubber composition is increased, and wet performance is enhanced. When the amount of the thermoplastic resin is less than 15 parts by mass, the effect of improving wear resistance and wet performance cannot be adequately achieved. When the amount of the thermoplastic resin exceeds 40 parts by mass, rolling resistance increases.

The thermoplastic resin is a resin usually blended in a rubber composition for a tire, has a molecular weight of about several hundreds to several thousands, and has a function of imparting adhesiveness to the rubber composition for a tire. The thermoplastic resin is preferably selected from the group consisting of: a resin composed of at least one selected from a terpene, a modified terpene, a rosin, a rosin ester, a C5 component, and a C9 component; and a resin with at least some double bonds hydrogenated in the resin. Examples thereof include a natural resin, such as a terpene resin, a modified terpene resin, a rosin resin, and a rosin ester resin; and a synthetic resin, such as a coal resin, a phenolic resin, a xylene resin, and a petroleum resin formed from a C5 component and/or a C9 component, such as a C5 resin, a C9 resin, and a C5C9 copolymer resin.

Examples of the terpene resin include α-pinene resin, β-pinene resin, limonene resin, hydrogenated limonene resin, dipentene resin, terpene phenol resin, terpene styrene resin, aromatic modified terpene resin, and hydrogenated terpene resin. Examples of the rosin resin include a modified rosin such as gum rosin, tall oil rosin, wood rosin, hydrogenated rosin, disproportionate rosin, polymerized rosin, maleinized rosin, and fumarized rosin; an ester derivative of the rosin such as a glycerine ester, a pentaerythritol ester, a methyl ester, and a triethylene glycol ester; and a rosin modified phenol resin.

Also, in the present invention, the thermoplastic resin preferably contains 25 mass % or more of the terpene resin. When the thermoplastic resin contains 25 mass % or more of the terpene resin, wet performance can be improved while rolling resistance is maintained at a low level. Moreover, the terpene resin may contain a unit derived from α-pinene, and the content of the unit derived from α-pinene may be limited to 60 mass % or less per 100 mass % of the terpene resin.

Examples of the petroleum resin include an aromatic hydrocarbon resin or, alternatively, a saturated or unsaturated aliphatic hydrocarbon resin. Examples thereof include a C5 petroleum resin (an aliphatic petroleum resin polymerized from fractions such as isoprene, 1,3-pentadiene, cyclopentadiene, methylbutene, and pentene), a C9 petroleum resin (an aromatic petroleum resin polymerized from fractions such as α-methylstyrene, o-vinyl toluene, m-vinyl toluene, and p-vinyl toluene), and a C5C9 copolymer petroleum resin.

The thermoplastic resin preferably has a glass transition temperature of from 40° C. to 120° C., preferably from 45° C. to 115° C., and more preferably from 50° C. to 110° C. The thermoplastic resin having a glass transition temperature of 40° C. or higher enhances dry grip performance and is preferred. Additionally, the thermoplastic resin having a Tg of 120° C. or lower enhances wear resistance and is preferred. The glass transition temperature of the thermoplastic resin can be measured by the method described above.

In addition to the components described above, the rubber composition for a tire may also contain various compounding agents that are commonly used in a rubber composition for a tire, in accordance with an ordinary method. Examples of the compounding agents include a vulcanization or crosslinking agent, a vulcanization accelerator, an anti-aging agent, a processing aid, a plasticizer, and a thermosetting resin. These compounding agents can be kneaded by a common method to obtain a rubber composition that can then be used for vulcanization or crosslinking. These compounding agents can be compounded in an amount commonly used in the related art so long as the object of the present invention is not hindered. The rubber composition for a tire can be prepared by mixing the above-mentioned components using a known rubber kneading machine such as a Banbury mixer, a kneader, or a roller.

The rubber composition for a tire is suitable for forming a tread portion or a side portion of a tire and is particularly suitable for forming a tread portion of a tire. In the resulting tire, wear resistance, wet performance, and low rolling resistance are improved beyond a level in the related art, and temperature dependency of the low rolling resistance is low, while extrusion processability is good. A tire of such excellent quality can be stably obtained.

Embodiments according to the present invention are further described below by Examples. However, the scope of the present invention is not limited to these Examples.

### EXAMPLE

In the preparation of 31 types of rubber composition for a tire (Standard Example, Examples 1 to 16, and Comparative Examples 1 to 14) having the common additive formulations indicated in Table 5 and having the compounding proportions indicated in Tables 1 to 4, components other than the sulfur and vulcanization accelerator were weighed into a 1.7 L sealed Banbury mixer and kneaded for 5 minutes, after which a master batch was discharged outside the mixer and cooled at room temperature. The master batch was placed in the Banbury mixer, and a sulfur and vulcanization accelerators were then added and mixed to obtain each of the rubber compositions for a tire. In the tables, SBR (B)-1 and SBR (B)-2 are oil extended products of 25 parts by mass, and SBR(B)-3 is an oil extended product of 20 parts by mass, and thus blended amounts excluding the oil-extending components are shown in parentheses below the amounts including the oil-extending components. The ratio of the total mass of the terminal-modified styrene-butadiene rubber (B) and natural rubber to the mass of the terminal-modified styrene-butadiene rubber (A) is presented in the row “Mass ratio (SBR(B)+NR)/SBR(A)”, and the weight-average molecular weight of the mixture of the terminal-modified styrene-butadiene rubber (B) and the natural rubber is presented in the row “Weight-average molecular weight of (SBR(B)+NR)”. Moreover, the average glass transition temperature of the diene rubber is described in the “Average Tg of diene rubber” row. Note that the additive formulation in Table 5 is expressed as values in parts by mass per 100 parts by mass of the diene rubbers described in Tables 1 to 4.

Each of the rubber compositions for a tire obtained as described above was vulcanized at 160° C. for 20 minutes in a mold having a predetermined form, and evaluation samples were thereby produced. Using the obtained evaluation samples, the dynamic visco-elasticity (loss tangent tan δ at 0° C., 20° C., and 60° C.) and wear resistance were measured by the following method. Additionally, the extrudability was evaluated by the following method using the obtained rubber compositions for a tire.

### Dynamic Visco-Elasticity (Loss Tangent tan δ at 0° C., 20° C., and 60° C.)

The dynamic visco-elasticity of the evaluation samples of the obtained rubber composition for a tire were measured using a viscoelastic spectrometer available from Iwamoto Seisakusho K.K. at an elongation deformation strain of 10±2%, a vibration frequency of 20 Hz, and temperatures of 0° C., 20° C., and 60° C. The dynamic visco-elasticity was thereby determined. The obtained results for the loss tangent tan δ at 0° C. are expressed as an index value based on the value of the Standard Example set at 100 and are presented in the “Wet performance” rows of Tables 1 to 4. Larger index values indicate a larger tan δ at 0° C. and excellent wet performance, and in the present description, an index value of 108 or higher indicates good wet performance. Each of the obtained results for the loss tangent tan δ at 60° C. was obtained by calculating a reciprocal thereof and is expressed as an index value based on the value of the Standard Example set at 100, and is presented in the “Rolling resistance” row of Tables 1 to 4. A larger value of this index value means a smaller tan δ at 60° C. and excellent rolling resistance performance, and in the present description, when this index value is 103 or higher, the low rolling resistance performance is considered to be good. Furthermore, a value was calculated by dividing the loss tangent tan δ at 60° C. by the loss tangent tan δ at 20° C. The value is expressed as an index value based on the value of the Standard Example set at 100 and is presented in the “Temperature dependency of rolling resistance” row in Tables 1 to 4. A larger value of this index means smaller temperature dependency of rolling resistance, and in the present description, when this index value is 105 or greater, the temperature dependency of low rolling resistance performance is small and considered to be excellent.

### Wear Resistance

Using a Lambourn abrasion test machine (available from Iwamoto Seisakusho K.K.), an amount of wear of the evaluation sample of the obtained rubber composition for a tire was measured in accordance with JIS K6264 under the following conditions: a load of 15.0 kg (147.1 N) and a slip rate of 25%. A reciprocal for each of the obtained results was calculated and shown in the “Wear resistance” rows in Tables 1 to 4 as an index value based on the reciprocal of the amount of wear of the Standard Example set at 100. A larger value of this index means a smaller wear amount and excellent wear resistance.

### Extrudability

Using the obtained rubber composition for a tire, extrusion samples were prepared using a Garvey die according to ASTM D 2230-77, and the 20 cm appearance (edge sharpness and smoothness of surface texture) of each extrusion sample was visually observed and evaluated on the basis of the following criteria. The results thereof are described in the “Extrudability” row of Tables 1 to 4. A rating score of 1 or 2 is considered to be excellent in extrudability.
1: There were no edge cuts and the surface was smooth.
2: Edge cuts occurred at 1 or more and 5 or fewer sections, and the surface was smooth.
3: Edge cuts occurred at 6 or more and 10 or fewer sections, and fuzz formation or holes were not observed on the surface.
4: Edge cuts occurred at 11 or more places, or fuzz formation or holes occurred on the surface.

TABLE 1

| | | Standard | Comparative | Comparative | Comparative | Comparative | Comparative | Comparative | Comparative |
|---|---|---|---|---|---|---|---|---|---|
| | | Example | Example 1 | Example 2 | Example 3 | Example 4 | Example 5 | Example 6 | Example 7 |
| SBR(A)-1 | Parts | 40 | 70 | 70 | 70 | 40 | 60 | 85 | 80 |
| | by mass | | | | | | | | |
| SBR-1 | Parts | | | | 10 | | | | |
| | by mass | | | | | | | | |
| SBR(B)-1 | Parts | 56.25 (45) | 37.5 (30) | 37.5 (30) | 12.5 (10) | | | | |
| | by mass | | | | | | | | |
| SBR(B)-2 | Parts | | | | | 37.5 (30) | | | |
| | by mass | | | | | | | | |
| SBR(B)-3 | Parts | | | | | | | | 12 (10) |
| | by mass | | | | | | | | |
| NR | Parts | 15 | | | 10 | 30 | 40 | 15 | 10 |
| | by mass | | | | | | | | |
| Thermoplastic | Parts | | | 20 | 20 | 20 | 20 | 20 | 20 |
| resin-1 | by mass | | | | | | | | |
| Carbon black | Parts | 10 | 10 | 10 | 10 | 10 | 10 | 10 | 10 |
| | by mass | | | | | | | | |
| Silica | Parts | 80 | 80 | 80 | 80 | 80 | 80 | 80 | 80 |
| | by mass | | | | | | | | |
| Coupling | Parts | 6.4 | 6.4 | 6.4 | 6.4 | 6.4 | 6.4 | 6.4 | 6.4 |
| agent-1 | by mass | | | | | | | | |
| Aroma oil | Parts | 25.00 | 28.75 | 8.75 | 13.75 | 8.75 | 16.25 | 16.25 | 14.25 |
| | by mass | | | | | | | | |
| Mass ratio (SBR(B) + NR)/SBR(A) | | 1.5 | 0.43 | 0.43 | 0.29 | 1.50 | 0.67 | 0.18 | 0.25 |
| Weight average molecular | | 795000 | 660000 | 660000 | 930000 | 1050000 | 1200000 | 1200000 | 965000 |
| weight of (SBR(B) + NR) | | | | | | | | | |
| Average Tg of | ° C. | −45.5 | −50.1 | −50.1 | −53.4 | −50.7 | −60.8 | −60.3 | −56.9 |
| diene rubber | | | | | | | | | |
| Rolling resistance | Index | 100 | 105 | 98 | 100 | 97 | 95 | 107 | 108 |
| | value | | | | | | | | |
| Temperature dependency | Index | 100 | 110 | 102 | 103 | 100 | 107 | 112 | 110 |
| of rolling resistance | value | | | | | | | | |
| Wet performance | Index | 100 | 90 | 104 | 101 | 103 | 95 | 98 | 102 |
| | value | | | | | | | | |
| Wear resistance | Index | 100 | 108 | 106 | 110 | 107 | 110 | 112 | 110 |
| | value | | | | | | | | |
| Extrudability | Rating | 1 | 3 | 4 | 3 | 1 | 1 | 4 | 3 |

TABLE 2

| | | Comparative | Comparative | Comparative | Comparative | Comparative | Comparative | Comparative |
|---|---|---|---|---|---|---|---|---|
| | | Example 8 | Example 9 | Example 10 | Example 11 | Example 12 | Example 13 | Example 14 |
| SBR(A)-1 | Parts by mass | 70 | 75 | | 75 | 75 | 75 | 75 |
| SBR-1 | Parts by mass | 10 | | 75 | | | | |
| SBR(B)-2 | Parts by mass | | 12.5 (10) | | | | | |
| SBR(B)-3 | Parts by mass | | | 12 (10) | 12 (10) | 12 (10) | 12 (10) | 12 (10) |
| NR | Parts by mass | 20 | 15 | 15 | 15 | 15 | 15 | 15 |
| Thermoplastic resin-1 | Parts by mass | 20 | 20 | 20 | 10 | 45 | 20 | 20 |
| Carbon black | Parts by mass | 10 | 10 | 10 | 10 | 10 | 10 | 10 |
| Silica | Parts by mass | 80 | 80 | 80 | 80 | 80 | 50 | 100 |
| Coupling agent-1 | Parts by mass | 6.4 | | 6.4 | 6.4 | 6.4 | 4.0 | 8.0 |
| Coupling agent-2 | Parts by mass | | | | | | | |
| Coupling agent-3 | Parts by mass | | 6.4 | | | | | |
| Aroma oil | Parts by mass | 16.25 | 13.75 | 14.25 | 24.25 | 0.0 | 14.25 | 14.25 |
| Mass ratio (SBR(B) + NR)/SBR(A) | | 0.29 | 0.33 | — | 0.33 | 0.33 | 0.33 | 0.33 |
| Weight average molecular | | 1200000 | 1080000 | 1080000 | 1012000 | 1012000 | 1012000 | 1012000 |
| weight of (SBR(B) + NR) | | | | | | | | |
| Average Tg of diene rubber | ° C. | −56.9 | −57 | −30.8 | −57 | −57 | −57 | −57 |
| Rolling resistance | Index value | 101 | 93 | 75 | 105 | 91 | 121 | 85 |
| Temperature dependency | Index value | 105 | 103 | 73 | 113 | 87 | 114 | 113 |
| of rolling resistance | | | | | | | | |
| Wet performance | Index value | 100 | 98 | 120 | 95 | 124 | 85 | 118 |
| Wear resistance | Index value | 108 | 107 | 85 | 105 | 108 | 100 | 93 |
| Extrudability | Rating | 3 | 2 | 3 | 3 | 2 | 1 | 2 |

TABLE 3

| | | Example 1 | Example 2 | Example 3 | Example 4 | Example 5 | Example 6 | Example 7 | Example 8 |
|---|---|---|---|---|---|---|---|---|---|
| SBR(A)-1 | Parts by mass | 75 | 75 | 75 | 50 | 50 | | | |
| SBR(A)-2 | Parts by mass | | | | | | 50 | 70 | 70 |
| SBR(B)-2 | Parts by mass | | 12.5 (10) | | 37.5 (30) | | | | |
| SBR(B)-3 | Parts by mass | | | 12 (10) | | 36 (30) | 36 (30) | 36 (30) | 36 (30) |
| NR | Parts by mass | 25 | 15 | 15 | 20 | 20 | 20 | | |
| Thermoplastic resin-1 | Parts by mass | 20 | 20 | 20 | 20 | 20 | 30 | 30 | 10 |
| Thermoplastic resin-2 | Parts by mass | | | | | | | | 20 |
| Carbon black | Parts by mass | 10 | 10 | 10 | 10 | 10 | 10 | 10 | 10 |
| Silica | Parts by mass | 80 | 80 | 80 | 80 | 80 | 80 | 80 | 80 |
| Coupling agent-1 | Parts by mass | 6.4 | 6.4 | 6.4 | 6.4 | 6.4 | 6.4 | 6.4 | 6.4 |
| Aroma oil | Parts by mass | 16.25 | 13.75 | 14.25 | 8.75 | 10.25 | 0.25 | 0.25 | 0.25 |
| Mass ratio (SBR(B) + NR)/SBR(A) | | 0.33 | 0.33 | 0.33 | 1.00 | 1.00 | 1.00 | 0.43 | 0.43 |
| Weight average molecular | | 1200000 | 1080000 | 1012000 | 1020000 | 918000 | 918000 | 730000 | 730000 |
| weight of (SBR(B) + NR) | | | | | | | | | |
| Average Tg of diene rubber | ° C. | −60.5 | −57 | −57 | −50.5 | −50.5 | −55.5 | −57.1 | −57.1 |
| Rolling resistance | Index value | 103 | 104 | 106 | 103 | 108 | 108 | 112 | 111 |
| Temperature dependency | Index value | 109 | 107 | 109 | 106 | 111 | 113 | 115 | 114 |
| of rolling resistance | | | | | | | | | |
| Wet performance | Index value | 100 | 103 | 105 | 110 | 115 | 115 | 118 | 118 |
| Wear resistance | Index value | 110 | 109 | 110 | 105 | 107 | 111 | 112 | 112 |
| Extrudability | Rating | 2 | 2 | 2 | 1 | 1 | 1 | 1 | 1 |

TABLE 4

| | | Example 9 | Example 10 | Example 11 | Example 12 | Example 13 | Example 14 | Example 15 | Example 16 |
|---|---|---|---|---|---|---|---|---|---|
| SBR(A)-1 | Parts | 50 | | | | 75 | | | 70 |
| | by mass | | | | | | | | |
| SBR(A)-2 | Parts | | 70 | 70 | 70 | | 70 | 70 | |
| | by mass | | | | | | | | |
| SBR(B)-3 | Parts | 36 (30) | 36 (30) | 36 (30) | 36 (30) | 12 (10) | 36 (30) | 36 (30) | |
| | by mass | | | | | | | | |
| NR | Parts | 20 | | | | 15 | | | 30 |
| | by mass | | | | | | | | |
| Thermoplastic | Parts | 20 | 10 | | | 20 | | | 20 |
| resin-1 | by mass | | | | | | | | |
| Thermoplastic | Parts | | 20 | 30 | | | | | |
| resin-2 | by mass | | | | | | | | |
| Thermoplastic | Parts | | | | 30 | | | | |
| resin-3 | by mass | | | | | | | | |
| Thermoplastic | Parts | | | | | | 30 | | |
| resin-4 | by mass | | | | | | | | |
| Thermoplastic | Parts | | | | | | | 30 | |
| resin-5 | by mass | | | | | | | | |
| Carbon black | Parts | 10 | 10 | 10 | 10 | 10 | 10 | 10 | 10 |
| | by mass | | | | | | | | |
| Silica | Parts | 80 | 80 | 80 | 80 | 80 | 80 | 80 | 80 |
| | by mass | | | | | | | | |
| Coupling | Parts | 4.8 | 4.8 | 6.4 | 6.4 | | 6.4 | 6.4 | 6.4 |
| agent-1 | by mass | | | | | | | | |
| Coupling | Parts | | | | | 6.4 | | | |
| agent-2 | by mass | | | | | | | | |
| Coupling | Parts | 1.6 | 1.6 | | | | | | |
| agent-3 | by mass | | | | | | | | |
| Aroma oil | Parts | 10.25 | 0.25 | 0.25 | 0.25 | 14.25 | 0.25 | 0.25 | 16.25 |
| | by mass | | | | | | | | |
| Mass ratio (SBR(B) + NR)/SBR(A) | | 1.00 | 0.43 | 0.43 | 0.43 | 0.33 | 0.43 | 0.43 | 0.43 |
| Weight average molecular | | 918000 | 730000 | 730000 | 730000 | 1012000 | 730000 | 730000 | 1200000 |
| weight of (SBR(B) + NR) | | | | | | | | | |
| Average Tg of diene | ° C. | −50.5 | −57.1 | −57.1 | −57.1 | −57 | −57.1 | −57.1 | −60 |
| rubber | | | | | | | | | |
| Rolling resistance | Index | 106 | 108 | 107 | 104 | 104 | 106 | 105 | 102 |
| | value | | | | | | | | |
| Temperature dependency | Index | 109 | 111 | 110 | 106 | 107 | 110 | 109 | 106 |
| of rolling resistance | value | | | | | | | | |
| Wet performance | Index | 113 | 115 | 116 | 114 | 101 | 116 | 116 | 109 |
| | value | | | | | | | | |
| Wear resistance | Index | 109 | 115 | 111 | 109 | 108 | 110 | 110 | 106 |
| | value | | | | | | | | |
| Extrudability | Rating | 1 | 1 | 1 | 2 | 1 | 1 | 1 | 1 |

The types of raw materials used in Tables 1 to 4 are described below.
SBR(A)-1: Nipol NS612 terminal-modified styrene-butadiene rubber having a polyorganosiloxane structure and available from Zeon Corporation; a non-oil extended product having a glass transition temperature of −60° C., a weight average molecular weight of 450000, a styrene content of 15 mass %, and a vinyl content of 31%.
SBR(A)-2: Terminal-modified styrene-butadiene rubber having a polyorganosiloxane structure and obtained by a polymerization method described below, a non-oil extended product having a glass transition temperature of −70° C., a weight average molecular weight of 450000, a styrene content of 18 mass %, and a vinyl content of 13%.
SBR-1: HPR850 styrene-butadiene rubber available from JSR Corporation, a non-oil extended product having a glass transition temperature of −25° C., a weight average molecular weight of 370000, a styrene content of 27.0 mass %, and vinyl content of 58.8%.
SBR(B)-1: NS560 terminal-modified styrene-butadiene rubber having a polyorganosiloxane structure and available from Zeon Corporation, an oil extended product at 25 parts by mass and having a glass transition temperature of −27° C., a weight average molecular weight of 660000, a bimodal molecular weight distribution curve when measured by GPC, a molecular weight distribution (PDI) of 1.5, a styrene content of 43 mass %, and a vinyl content of 31%.
SBR(B)-2: F3420 terminal-modified styrene-butadiene rubber having an alkoxysilyl group and available from Asahi Kasei Corporation, an oil extended product at 25 parts by mass and having a glass transition temperature of −27° C., a weight average molecular weight of 900000, a unimodal molecular weight distribution curve when measured by GPC, a molecular weight distribution (PDI) of 2.3, a styrene content of 36 mass %, and a vinyl content of 40%.
SBR(B)-3: A terminal-modified styrene-butadiene rubber having an alkoxysilyl group and obtained by a polymerization method described below, an oil extended product at 20 parts by mass and having a glass transition temperature of −31° C., a weight average molecular weight of 730000, a unimodal molecular weight distribution curve when measured by GPC, a molecular weight distribution (PDI) of 1.3, a styrene content of 36 mass %, and a vinyl content of 38%.
NR: Natural rubber, SIR-20; glass transition temperature: −62° C., weight average molecular weight: 1200000.
Thermoplastic resin-1: YS resin TO-125, an aromatic modified terpene resin available from Yasuhara Chemical Co., Ltd.; glass transition temperature: 78° C.
Thermoplastic resin-2: Neopolymer S100, a C₉ resin available from Eneos Corporation: glass transition temperature: 58° C.
Resin-3: α-pinene resin, glass-transition temperature: 81° C., softening point: 130° C., Mn: 742 g/mol, Mz: 1538 g/mol, Mw: 1055 g/mol, Mw/Mn: 1.42.
Resin-4: YS resin PX-1150N, a β-pinene resin available from Yasuhara Chemical Co., Ltd.; glass transition temperature: 68° C.
Resin-5: pinene resin (α-pinene: 20 mass %, β-pinene: 80 mass %), glass transition temperature: 78° C., softening point: 130° C., Mn: 790 g/mol, Mz: 1891 g/mol, Mw: 1101 g/mol, Mw/Mn: 1.57.
Carbon black: Show Black N339 available from Cabot Japan K.K., CTAB adsorption specific surface area: 90 m²/g.
Silica: ZEOSIL 1165MP, available from Solvay
Coupling agent-1: a silane coupling agent containing polysiloxane and represented by the average compositional formula of General Formula (1), available from Shin-Etsu Chemical Co., Ltd.; a polysiloxane represented by the average compositional formula (—C₃H₆—S₄—C₃H₆—)_{0.071}(—C₈H₁₇)_{0.571}(—OC₂H₅)_{1.50}(—C₃H₆SH)_{0.286}SiO_{0.75}
Coupling agent-2: NXT Silane available from Momentive Performance Materials, Inc., a silane coupling agent in which R² to R⁴ in General Formula (2) are ethoxy groups and R⁵ is an n-heptyl group; 3-octanoylthio-1-propyltriethoxysilane.
Coupling agent-3: Si69, a silane coupling agent available from Evonik Degussa Corporation.
Low aroma oil: Extract No. 4S, available from Shell Lubricants Japan K.K.

### SBR(A)-2 Polymerization Method

In a nitrogen-purged 800-mL ampoule bottle, 70.0 g of cyclohexane and 0.77 mmol of tetramethylethylenediamine were added, after which 7.69 mmol of n-butyllithium was further added. Next, 27.9 g of isoprene and 2.1 g of styrene were slowly added, and the mixture was reacted for 120 minutes in the ampoule bottle at a temperature set to 50° C., and thereby a polymer block having an active terminal was obtained.

An autoclave with a stirrer was charged with 4000 g of cyclohexane, 1.50 mmol of tetramethylethylenediamine, 445 g of 1,3-butadiene, and 155 g of styrene in a nitrogen atmosphere, after which the entire amount of the above-obtained polymer block having an active terminal was added thereto, and polymerization was initiated at 50° C. Ten minutes after polymerization was initiated, 355 g of 1,3-butadiene and 40 g of styrene were continuously added over the course of 60 minutes. The maximum temperature during the polymerization reaction was 75° C. After the continuous addition was completed, the polymerization reaction was continued for another 10 minutes until it was confirmed that the polymer conversion ratio reached a range from 95% to 100%. Then 2.44 g of a polyorganosiloxane represented by the following Formula (I) was added in the state of a xylene solution with a concentration at 40 mass %, and the mixture was reacted for 30 minutes. Subsequently, methanol of an amount equivalent to twice the number of moles of n-butyllithium used was added as a polymerization terminator, and a solution containing a conjugated diene rubber was obtained. To this solution, Irganox 1520L (available from BASF) was added as an anti-aging agent at an amount of 0.15 parts per 100 parts of the conjugated diene rubber, after which the solvent was removed by steam stripping, the resulting substance was vacuum-dried for 24 hours at 60° C., and a solid conjugated diene rubber [SBR(A]-2] was obtained.

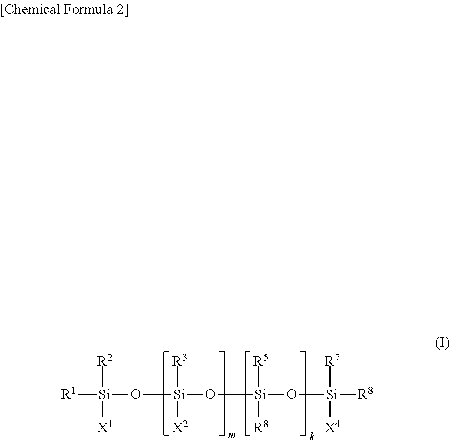

In the above Formula (I), m is 80, k is 120, X¹, X⁴, R¹ to R³ and R⁵ to R⁸ are methyl groups, and X² is a group represented by the following Formula (II) (wherein, * represents a bonding position).

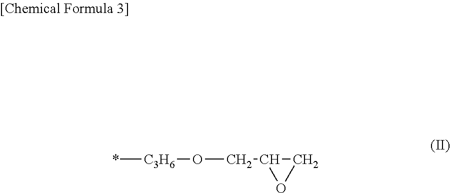

### SBR(B)-3 Polymerization Method

In a first reactor of a continuous reactor system in which three reactors are connected in series, a styrene solution obtained by dissolving 60 mass % of styrene in n-hexane was injected at a rate of 6.5 kg/h, a 1,3-butadiene solution obtained by dissolving 60 mass % of 1,3-butadiene in n-hexane was injected at a rate of 7.7 kg/h, n-hexane was injected at a rate of 47.0 kg/h, a 1,2-butadiene solution obtained by dissolving 2.0 mass % of 1,2-butadiene in n-hexane was injected at a rate of 40 g/h, a solution obtained by dissolving 10 mass % of N,N,N′,N′-tetramethylethylenediamine (TMEDA) in n-hexane was injected as a polar additive at a rate of 50.0 g/h, and a modification initiator produced in Production Example 1 below was injected at a rate of 400.0 g/h. At this time, the temperature of the first reactor was maintained at 55° C., and when the polymerization conversion ratio reached 41%, the polymerized material was transferred from the first reactor to the second reactor through a transfer pipe.

Next, in a second reactor, a 1,3-butadiene solution obtained by dissolving 60 mass % of 1,3-butadiene in n-hexane was injected at a rate of 2.3 kg/h. At this time, the temperature of the second reactor was maintained at 65° C., and when the polymerization conversion ratio reached 95% or higher, the polymerized material was transferred from the second reactor to the third reactor through a transfer pipe.

The polymerized material was transferred from the second reactor to the third reactor, and a solution in which N-(3-(1H-1,2,4-triazol-1-yl)propyl)-3-(trimethoxysilyl)-N-(3-(trimethoxysilyl) propyl)propane-1-amine was dissolved (solvent: n-hexane) as a modifying agent was charged continuously in the third reactor [modifying agent: act. Li (polymerization initiator)=1:1 mol]. The temperature of the third reactor was maintained at 65° C.

Thereafter, in the polymerization solution discharged from the third reactor, a solution in which 30 mass % of IR1520 (available from BASF) was dissolved as an antioxidant was charged at a rate of 170 g/h and agitated. The polymerized material obtained as a result was inserted into warm water heated by steam, the solvent was removed by agitation, and a modified conjugated diene polymer [modified SBR(B)-3] was thereby produced.

### Production Example 1: Production of Modification Initiator

Two vacuum dried 4 L stainless steel pressure vessels were prepared. In a first pressure vessel, 6922 g of cyclohexane, 85 g of a compound represented by Chemical Formula (i) below, and 60 g of tetramethylethylenediamine were charged, and a first reaction solution was produced. At the same time, in a second pressure vessel, 180 g of 2.0 M liquid n-butyllithium and 6926 g of cyclohexane were charged, and thus a second reaction solution was produced. At this time, the molar ratio of the compound represented by Chemical Formula (i) to n-butyllithium to tetramethylethylenediamine was 1:1:1. In a condition where the pressure of each of the pressure vessels was maintained at 7 bar, using a mass flowmeter, the first reaction solution was charged in a continuous reactor system through a first continuous channel at an injection rate of 1.0 g/min and the second reaction solution was charged in the continuous reactor through a second continuous channel at an injection rate of 1.0 g/min. At this time, the temperature in the continuous reactor system was maintained at −10° C., the internal pressure was maintained at 3 bar by using a back pressure regulator, and the retention time in the reactor was adjusted to 10 minutes or less. The reaction was terminated, and thus a modification initiator was obtained.

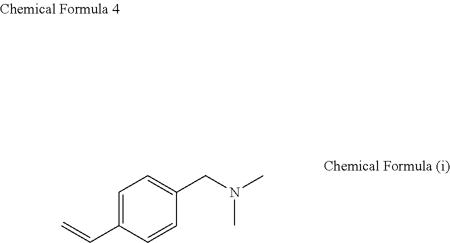

TABLE 5
Common additive formulation

| | |
|---|---|
| Zinc oxide | 2.5 Parts by mass |
| Stearic acid | 2.0 Parts by mass |
| Anti-aging agent | 3.2 Parts by mass |
| Vulcanization accelerator-1 | 2.0 Parts by mass |
| Vulcanization accelerator-2 | 2.0 Parts by mass |
| Sulfur | 1.5 Parts by mass |

The types of raw materials used as indicated in Table 5 are described below.
Zinc oxide: Zinc Oxide III, available from Seido Chemical Industry Co., Ltd.
Stearic acid: Stearic Acid YR available from NOF Corp.
Anti-aging agent: Santoflex 6PPD, available from Solutia Europe
Vulcanization accelerator-1: NOCCELER CZ-G, available from Ouchi Shinko Chemical Industrial Co., Ltd.
Vulcanization accelerator-2: Soxinol D-G, available from Sumitomo Chemical Co., Ltd.
Sulfur: Golden Flower oil treated sulfur powder, available from Tsurumi Chemical Industry Co., Ltd.

As clearly shown in Tables 3 and 4, the rubber composition for a tire of the Examples 1 to 16 can improve wear resistance, wet performance, and low rolling resistance beyond a level in the related art, and reduce the temperature dependency of the low rolling resistance, while providing excellent extrusion forming processability.

Moreover, as clearly shown in Table 1, the rubber composition for a tire of Comparative Example 1 is not formulated with the thermoplastic resin, and therefore has low wet performance. Moreover, the weight average molecular weight of the mixture composed of the terminal-modified styrene-butadiene rubber (B) and the natural rubber is less than 700000, and thus the extrusion forming processability is poor.

The rubber composition for a tire of Comparative Example 2 is formulated with the thermoplastic resin, but the weight average molecular weight of the mixture composed of the terminal-modified styrene-butadiene rubber (B) and the natural rubber is less than 700000, and thus the extrusion forming processability is poor. Also, the low rolling resistance cannot be improved.

In the rubber composition for a tire of Comparative Example 3, the total mass of the terminal-modified styrene-butadiene rubber (B) and the natural rubber is less than ⅓ the mass of the terminal-modified styrene-butadiene rubber (A), and therefore the extrusion forming processability is poor.

The rubber composition for a tire of Comparative Example 4 contains less than 50 mass % of the terminal-modified styrene-butadiene rubber (A), and therefore has poor rolling resistance.

The rubber composition for a tire of Comparative Example 5 contains more than 30 mass % of the natural rubber, and therefore has poor wet performance and rolling resistance.

In the rubber composition for a tire of Comparative Example 6, the content of the terminal-modified styrene-butadiene rubber (A) exceeds 75 mass %, and the total mass of the terminal-modified styrene-butadiene rubber (B) and the natural rubber is less than one third the mass of the terminal-modified styrene-butadiene rubber (A), and therefore the wet performance and the extrusion forming processability are poor.

In the rubber composition for a tire of Comparative Example 7, the content of the terminal-modified styrene-butadiene rubber (A) exceeds 75 mass %, and the total mass of the terminal-modified styrene-butadiene rubber (B) and the natural rubber are less than one third the mass of the terminal-modified styrene-butadiene rubber (A), and therefore the extrusion forming processability is poor.

As is clear from Table 2, in the rubber composition for a tire of Comparative Example 8, the total mass of the terminal-modified styrene-butadiene rubber (B) and the natural rubber is less than one third the mass of the terminal-modified styrene-butadiene rubber (A), and therefore the extrusion forming processability is poor.

In the rubber composition for a tire of Comparative Example 9, the silane coupling agent does not have a mercapto structure, and therefore the wet performance and rolling resistance are poor.

The rubber composition for a tire of Comparative Example 10 does not contain the terminal-modified styrene-butadiene rubber (A), and therefore has increased rolling resistance and temperature dependency of the rolling resistance, and reduced wear resistance. In addition, the extrusion forming processability is poor.

The rubber composition for a tire of Comparative Example 11 contains less than 15 parts by mass of the thermoplastic resin, and therefore has poor wet performance and extrusion forming processability.

In the rubber composition for a tire of Comparative Example 12, the content of the thermoplastic resin exceeds 40 parts by mass, and therefore the rolling resistance is high, and the temperature dependency of the rolling resistance is high.

The rubber composition for a tire of Comparative Example 13 contains less than 60 parts by mass of silica, and therefore the wet performance is poor, and wear resistance is not improved.

In the rubber composition for a tire of Comparative Example 14, the silica content exceeds 90 parts by mass, and therefore the rolling resistance is increased, and wear resistance is reduced.

The present disclosure includes the following embodiments of the invention.
Invention [1] A rubber composition for a tire containing: from 60 to 90 parts by mass of silica and from 15 to 40 parts by mass of a thermoplastic resin blended in 100 parts by mass of a diene rubber, the diene rubber containing a terminal-modified styrene-butadiene rubber (A) and containing a natural rubber and/or a terminal-modified styrene-butadiene rubber (B); and a silane coupling agent having a mercapto structure at an amount from 2 to 15 mass % of the mass of the silica, wherein the terminal-modified styrene-butadiene rubber (A) may have a weight average molecular weight of from 300000 to 500000 and a glass transition temperature of −50° C. or lower, the terminal-modified styrene-butadiene rubber (B) may have a weight average molecular weight of 600000 or greater, a mixture containing the terminal-modified styrene-butadiene rubber (B) and the natural rubber may have a weight average molecular weight of 700000 or greater, the diene rubber may have an average glass transition temperature of −50° C. or lower, and in 100 mass % of the diene rubber, a content of the terminal-modified styrene-butadiene rubber (A) may be from 50 to 75 mass %, a content of the natural rubber may be from 0 to 30 mass %, and the total mass of the terminal-modified styrene-butadiene rubber (B) and the natural rubber may be ⅓ or more of a mass of the terminal-modified styrene-butadiene rubber (A).
Invention [2] The rubber composition for a tire according to invention [1], wherein the styrene-butadiene rubber (B) may have a unimodal molecular weight distribution curve of the terminal-modified with a molecular weight distribution (PDI) of less than 1.7 when measured by gel permeation chromatography.
Invention [3] The rubber composition for a tire according to invention [1] or [2], wherein the content of the terminal-modified styrene-butadiene rubber (B) in 100 mass % of the diene rubber may be from 0 to 50 mass %.
Invention [4] The rubber composition for a tire according to any one of inventions [1] to [3], wherein the thermoplastic resin may contain 25 mass % or more of a terpene resin, and when the terpene resin includes a unit derived from α-pinene, the content of the unit derived from α-pinene may be 60 mass % or less.
Invention [5] The rubber composition for a tire according to any one of inventions [1] to [4], wherein the thermoplastic resin may have a glass transition temperature of from 40° C. to 120° C.
Invention [6] The rubber composition for a tire according to any one of inventions [1] to [4], wherein the thermoplastic resin may be at least one selected from the group consisting of: a resin composed of at least one selected from a terpene, a modified terpene, a rosin, a rosin ester, a C5 component, and a C9 component; and a resin with at least some double bonds hydrogenated in the resin, and the thermoplastic resin may have a glass transition temperature of from 40° C. to 120° C.
Invention [7] A tire having a tread portion made from the rubber composition for a tire according to any one of inventions [1] to [6].

### REFERENCE SIGNS LIST

1 Tread portion
2 Side portion
3 Bead portion
4 Carcass layer
5 Bead core
6 Bead filler
7 Innerliner layer
8 Belt layer
9 Belt cover layer
10a Cap tread
10b Undertread

1. A rubber composition for a tire comprising: from 60 to 90 parts by mass of silica and from 15 to 40 parts by mass of a thermoplastic resin blended in 100 parts by mass of a diene rubber, the diene rubber including a terminal-modified styrene-butadiene rubber (A) and including a natural rubber and/or a terminal-modified styrene-butadiene rubber (B); and a silane coupling agent having a mercapto structure at an amount from 2 to 15 mass % of the mass of the silica;
the terminal-modified styrene-butadiene rubber (A) having a weight average molecular weight of from 300000 to 500000 and a glass transition temperature of −50° C. or lower,
the terminal-modified styrene-butadiene rubber (B) having a weight average molecular weight of 600000 or greater,
a weight average molecular weight of a mixture consisting of the terminal-modified styrene-butadiene rubber (B) and the natural rubber being 700000 or greater,
the diene rubber having an average glass transition temperature of −50° C. or lower, and
in 100 mass % of the diene rubber, a content of the terminal-modified styrene-butadiene rubber (A) being from 50 to 75 mass %, a content of the natural rubber being from 0 to 30 mass %, and a total mass of the terminal-modified styrene-butadiene rubber (B) and the natural rubber being ⅓ or more of a mass of the terminal-modified styrene-butadiene rubber (A).

2. The rubber composition for a tire according to claim 1, wherein the terminal-modified styrene-butadiene rubber (B) has a unimodal molecular weight distribution curve with a molecular weight distribution (PDI) of less than 1.7 when measured by gel permeation chromatography.

3. The rubber composition for a tire according to claim 1, wherein a content of the terminal-modified styrene-butadiene rubber (B) is from 0 to 50 mass % in 100 mass % of the diene rubber.

4. The rubber composition for a tire according to claim 1, wherein
the thermoplastic resin contains 25 mass % or more of a terpene resin, and
when the terpene resin has a unit derived from α-pinene, a content of the unit derived from α-pinene is 60 mass % or less.

5. The rubber composition for a tire according to claim 1, wherein the thermoplastic resin has a glass transition temperature of from 40° C. to 120° C.

6. The rubber composition for a tire according to claim 1, wherein
the thermoplastic resin is at least one selected from the group consisting of: a resin consisting of at least one selected from a terpene, a modified terpene, a rosin, a rosin ester, a C5 component, and a C9 component; and a resin with at least some double bonds hydrogenated in the resin; and
the thermoplastic resin having a glass transition temperature of from 40° C. to 120° C.

7. A tire comprising a tread portion made from the rubber composition for a tire described in claim 1.
